(19) United States
(12) Patent Application Publication
(10) Pub. No.: US 2011/0298604 A1
(43) Pub. Date: Dec. 8, 2011

(54) Protective Advertisement Cover for Barriers

(76) Inventor: Kristopher Loodvik Peerali, Hidden Hills, CA (US)

(21) Appl. No.: 13/152,459

(22) Filed: Jun. 3, 2011

Related U.S. Application Data
(60) Provisional application No. 61/350,972, filed on Jun. 3, 2010.

(51) Int. Cl. B60Q 1/00; B23P 11/02; E01F 13/00; G09F 15/00; E01F 15/00

(52) U.S. Cl. 340/436; 40/606.03; 40/542; 40/541; 29/446

(57) ABSTRACT

A protective advertisement cover for barriers is disclosed. The cover functions as both a protective cover and as an advertising substrate. The cover provides damage control and protection to anything coming into proximal contact with the bather while an advertisement component makes the barrier more noticeable and therefore more avoidable to customers, pedestrians, workers, trespassers and the like. The disclosed cover includes a shock absorbing component layer configured to absorb shock and substantially return to its original form after impact from a third object. The cover also includes an advertisement component layer that may be disparate from the underlayment shock absorbing layer or imprinted directly thereon. Additionally, the disclosed protective advertisement cover includes a transparent and deformable component layer which may shield the advertisement from weather and graffiti and contribute to protecting motor vehicle doors and body parts from damage by a bather.

### CROSS-REFERENCE TO RELATED APPLICATION

This application claims the benefit of the priority date of earlier filed U.S. Provisional Patent Application Ser. No. 61/350,972, filed Jun. 3, 2010 for Kristopher L. Peerali titled, A Protective Advertisement Cover for Barriers, incorporated herein by reference in its entirety.

### BACKGROUND OF THE INVENTION

Barriers come in many sizes and shapes. Barriers may be cylindrical, conical, square, rectangular and even circular. Barriers may be found near gas station pumps, public utilities, parking lots, buildings, public phones, and on factory floors to protect people from machinery and also to protect assets from damage. Barriers may be stationary, displaceable and mechanically operated in moments of emergency. Barriers are therefore useful and necessary for the public welfare and commercial operations. But because barriers are placed by a proprietor, barriers are designed to protect an asset or avoid a lawsuit rather than to protect the customer or a possible tortfeaser. For instance, barriers may be constructed out of coarse metal and filled with concrete and therefore easily damage a motor vehicle door or most anything else making contact with the barrier.

Particularly troublesome to gasoline consumers are the hoop barriers and bollards that are placed near enough to gasoline pumps to protect the pumps against errant motor vehicles. Such barriers are also close enough to cause damage to a motor vehicle's door when opened for passenger egress to pump gasoline and pay a charge. The most common form of damage may occur when a customer opens a motor vehicle's door onto a metal bollard or a hoop barrier leaving paint and body damage and a disgruntled customer. Customers have also been known to wrap their motor vehicle around a barrier turning too sharply leaving a pump station. Damage of significance may therefore occur to a motor vehicle before a customer is even aware of the harm caused by their actions.

Aftermarket bumpers may be placed on a motor vehicle door designed to protect the door from contact with another motor vehicle along a limited edge of the door. However, such bumpers may not be effective against a cylindrical surface posed by a bollard or hoop bather. Even vehicles with built-in bumper strips mitigate but do not avoid costly damage from a sideswipe with a barrier. A market therefore exists for a device which may control the damage done to a motor vehicle from a barrier.

### SUMMARY OF THE INVENTION

A protective advertisement cover for barriers is disclosed. The cover functions as both a protective cover and as an advertising display substrate. The cover provides damage control and protection to anything coming into proximal and immediate contact with the barrier while an advertising display component layer makes the barrier more noticeable and therefore more avoidable to customers, pedestrians, workers, trespassers and the like.

The disclosed cover includes a shock absorbing component layer configured to absorb shock and substantially return to its original form after impact with a third object. The cover also includes a display component layer for advertising that may be disparate from the supporting shock absorbing layer or may be imprinted directly thereon. Additionally, the disclosed protective advertisement cover includes a transparent and deformable component layer which may shield the advertisement from weather and graffiti and contribute to protecting motor vehicle doors and body parts from damage by a barrier.

A method for attaching an advertisement to a barrier is also disclosed. The method includes covering the barrier in a longitudinal direction with a plurality of contiguous shock absorbing panels. The method also includes disposing an advertisement on the shock absorbing panels, the advertisement configured to make the barrier noticeable and avoidable. The method additionally includes wrapping a protective cover around the barrier in a longitudinal direction, the cover configured to be transparent and deformable and shield the advertisement from weather and graffiti. Furthermore, the disclosed method includes attaching a first end of the protective cover to a second end to secure the component layers around the barrier in one of a temporary and permanent manner

Additionally, a method for protecting a vehicle from impact with a barrier is disclosed herein. The method includes covering the barrier with an advertisement configured to attract the attention of a consumer in a vehicle near the barrier. The method also includes attracting the consumer's attention to the barrier via covering the barrier with the advertisement. The disclosed method additionally includes the consumer managing the vehicle to avoid an impact to the vehicle with the bollard barrier covered with the advertisement.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts the placement of a shock absorbing component of a protective advertisement cover onto a bollard type barrier in accordance with an embodiment of the present disclosure.

FIG. 2 depicts adjacent shock absorbing components of a protective advertisement cover on a bollard type barrier in accordance with an embodiment of the present disclosure.

FIG. 3 depicts the placement of an advertising component of the disclosed cover onto the shock absorbing component on a bollard type barrier in accordance with an embodiment of the present disclosure.

FIG. 4 depicts the placement of a shock absorbing component of a protective advertisement cover onto a hoop type barrier in accordance with an embodiment of the present disclosure.

FIG. 5 depicts adjacent shock absorbing components of a protective advertisement cover on a hoop type barrier in accordance with an embodiment of the present disclosure.

FIG. 6 depicts the placement of an advertising component of the disclosed cover onto the shock absorbing component on a hoop type barrier in accordance with an embodiment of the present disclosure.

FIG. 7 depicts multiple component layers that may be disposed adjacent each other and adjacent the shock absorbing component of the disclosed cover in accordance with an embodiment of the present disclosure.

FIG. 8 is a flow chart of a method for attaching a cover to a bather in accordance with an embodiment of the present disclosure.

FIG. 9 is a flow chart of a method for protecting a vehicle from to impact with a barrier in accordance with an embodiment of the present disclosure.

Throughout the description, similar reference numbers used in one figure may be used to identify similar elements in other figures.

### DETAILED DESCRIPTION

Reasons for unintended contact with a bather may include uncontrolled placement of an automobile door caught by a wind gust, failure to see the barrier and misjudging the distance from an automobile door to the bather. Customers from high clearance vehicles may not even be aware of a barrier because they can't see it through their window prior to opening their door or pulling out of a gas station pump area. Customers in lower clearance vehicles may not notice a barrier that is non-descript and taken for granted as part of the conventional pump station.

One definition of advertising is to call something to public attention. Embodiments of the disclosed cover present a message through display, advertising and variable presentment to capture a customer's attention and therefore make it less likely that the customer will bang his or her door against the bather. An information kiosk may also be included in embodiments of the disclosure to engage and capture consumer's attention to the barrier. Such an information kiosk may therefore display safety procedures for pumping gas and any other information deemed useful or necessary by the management of the premises of the barrier. Embodiments of the disclosure may additionally include at least one rebate coupon dispenser disposed on the cover layer. The rebate coupons may be detachable from the cover for consumers and thereby attract attention to the barrier and make it noticeable and avoidable. The disclosed cover may therefore allow a customer to avoid the more serious sideswiping damage to a vehicle from exiting too sharply from a gasoline pumping area.

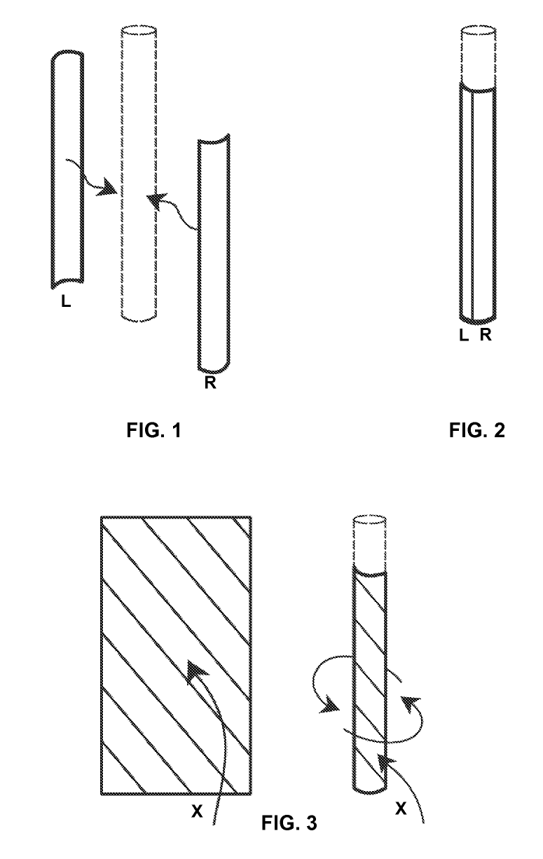

FIG. 1 depicts the placement of a shock absorbing component of a protective advertisement cover onto a bollard type barrier in accordance with an embodiment of the present disclosure. The shock absorbing component may be comprised of a foam rubber material, elastomeric materials, low durometer plastics and/or any material capable of absorbing impact from a third object and to substantially returning to its original form. A left component L and a right component R may comprise three hundred and sixty degree perimeter coverage of the bollard in a longitudinal direction. The placement shown avoids the friction between the bollard and the shock absorbing component that may result from sliding a single cylindrical shock absorbing component over the top and down the sides of the bollard. The placement shown allows a snug fit between the shock absorbing component and the bollard without the need for lubricants and/or stretchable shock absorbing materials.

FIG. 2 depicts adjacent shock absorbing components of a protective advertisement cover on a bollard type barrier in accordance with an embodiment of the present disclosure. The shock absorbing components thus adjacent may be affixed to the bollard or may be affixed to each other by a permanent or temporary force until a subsequent supporting layer is provided as disclosed. The shock absorbing components therefore cover the cylindrical perimeter of the bollard and provide protection and damage control to an automobile door, body, bumper, trailer and other devices. The degree of protection provided may be determined by the combination of the shock absorbing component and the other component layers comprising the disclosed cover as described herein.

FIG. 3 depicts the placement of an advertising component of the disclosed cover onto the shock absorbing component on a bollard type barrier in accordance with an embodiment of the present disclosure. The advertising component, depicted by a stripped pattern on layer X, may either be an additional component layer or be imprinted into the shock absorbing component. It is advantageous for the advertisement to be comprised of an additional component layer such as a paper product, a plastic product, or any other advertising media in order to be periodically replaced as needed.

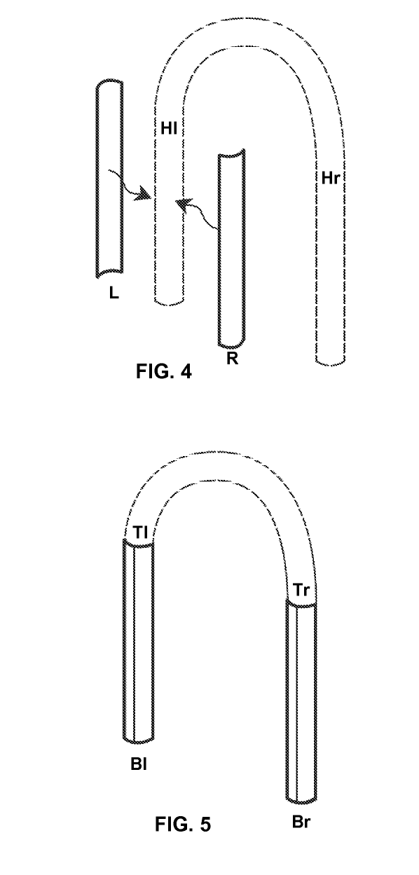

FIG. 4 depicts the placement of a shock absorbing component of a protective advertisement cover onto a hoop type barrier in accordance with an embodiment of the present disclosure. Though the depiction shows only the placement of shock absorbing components onto the left leg H1 of the hoop barrier, other similar shock absorbing components may likewise be placed on the right leg Hr of the hoop bather. The shock absorbing component may be comprised of a foam rubber material, elastomeric materials, low durometer plastics and/or any to material capable of absorbing impact from a third object and substantially returning to its original form. Alternate embodiments may also include placement of a shock absorbing component of the disclosed cover onto bathers of various sizes and shapes including but not limited to cylindrical, conical, pyramidal, square, rectangular and circular bollards. Decorative bollards of classical and modern styles may also be covered by the shock absorbing component of the disclosed cover.

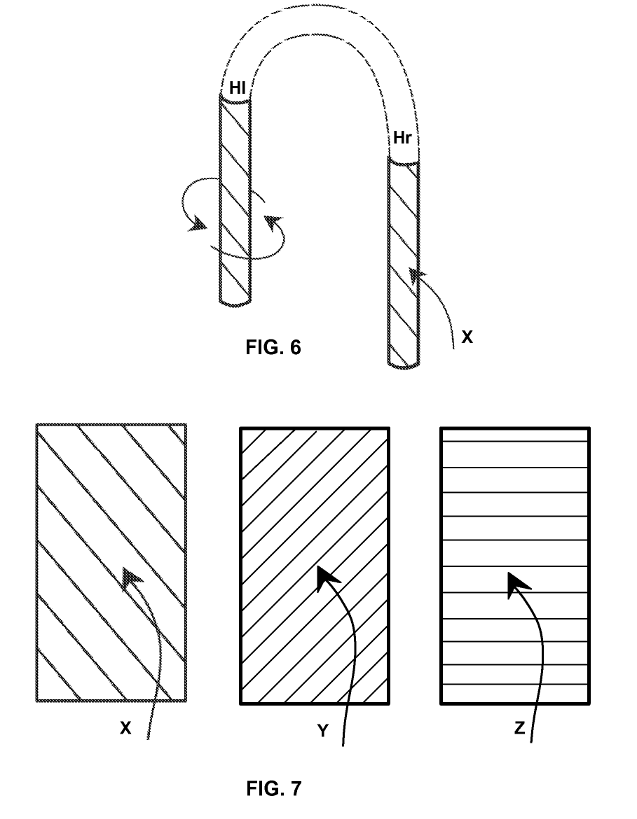

FIG. 5 depicts adjacent shock absorbing components of a protective advertisement cover on a hoop type barrier in accordance with an embodiment of the present disclosure. The degree of protection provided may be determined by the combination of the shock absorbing component and the other component layers comprising the disclosed cover as described herein. Also included in an embodiment is a unitary shock absorbing component which may wrap around leg H1 with adjacent ends touching at the line Tl-Bl and a second unitary shock absorbing component wrapped around leg Hr with adjacent ends touching as shown by the line Tr-Br. The unitary shock absorbing component may therefore be comprised of sheet material capable of deforming around respective legs of the hoop bather. Alternatively, the unitary shock absorbing component may be precast into various barrier shapes and sizes to facilitate a snug placement around any barrier. Multiple panels of the various component layers may also be precast into a variety of shapes and sizes and affixed to the barrier to effect a snug placement of the cover on the barrier.

FIG. 6 depicts the placement of an advertising component of the disclosed cover onto the shock absorbing component on a hoop type barrier in accordance with an embodiment of the present disclosure. The advertising components, depicted by a stripped pattern, may either be an additional component layer such as layer X or be directly imprinted or embedded onto and into the shock absorbing component. It is advantageous for the advertisement to be comprised of an additional component layer such as a paper product, a plastic product, or any other advertising media in order to be periodically replaced as needed. The advertisement of leg H1 may either be a copy of the advertisement of leg Hr or it may be an entirely different advertisement. In situations where an advertisement is temporarily unavailable or undesired, at least one component to layer may include a warning sign in safety yellow and any other appropriate attention capturing colors and graphics.

FIG. 7 depicts multiple component layers that may be disposed adjacent each other and adjacent the advertisement and shock absorbing component layers of the disclosed cover in accordance with an embodiment of the present disclosure. The multiple component layers X, Y and Z may be applied to any of the disclosed covers in preceding FIGS. 1 through 6 and may include a transparent vinyl layer for protecting the advertisement layer from the effects of weather and graffiti. The multiple component layers may also include an underlayment of temporary or permanent adhesive to secure the shock absorbing component layer to the bollard or hoop barrier. Therefore, the present disclosure includes any number of additional component layers configured to display, advertise, absorb shock and impact and protect a plurality of substrate components and the barrier itself. The disclosed cover may also protect objects coming into contact with the barrier such as vehicles, persons, animals, shopping carts, sporting goods and any other non-stationary object.

Some of the multiple component layers may be imbued with a fluorescent pigment particularly to facilitate nighttime detectability and to facilitate reading an enclosed advertisement or display during dusk or nighttime hours of the day. Also chemiluminescent glow sticks and/or glow panels may be comprised in some of the multiple component layers to facilitate reading the enclosed advertisement during nighttime hours. Embodiments of the disclosed cover may additionally include component layers of flexible electronic displays including light emitting diodes (LED) powered from local DC battery power and/or distributed AC electric power and a solar panel, the LED configurable to flash at a variable rate and intensity in order to bring attention to the barrier and make it avoidable to a consumer and his or her vehicle.

In embodiments of the disclosed cover, the transparent vinyl layer may also comprise grommet pairs and string, snap pairs, hoop and loop complementary surfaces or materials such as a VELCRO® material and/or other adhesive materials for affixing adjacent ends to each other or to adjacent layers to secure the component layers around the barrier in a temporary or permanent manner. Therefore, embodiments may include a light adhesive layer to secure the shock absorbing layer to the bather and allow changing the advertisement by access through the vinyl top component layer. The top transparent layer may therefore be secured by string tied through grommets on both edges of the vinyl layer and by other means disclosed herein.

Embodiments of the present disclosed advertisement and protective cover for barriers may also include extended height covers comprising components which extend beyond the height of the barrier to provide detectability to Recreational Vehicles (RV) and high clearance motor vehicles. Embodiments may also include shock activated audible alarms which alert a driver to immediate impact with the barrier in cases where a driver may start to sideswipe a barrier by a sharp turn exiting a barrier protected pump station. Shock activated alarms may be disposed under the cover layer or between or on top of any of the disclosed component layers.

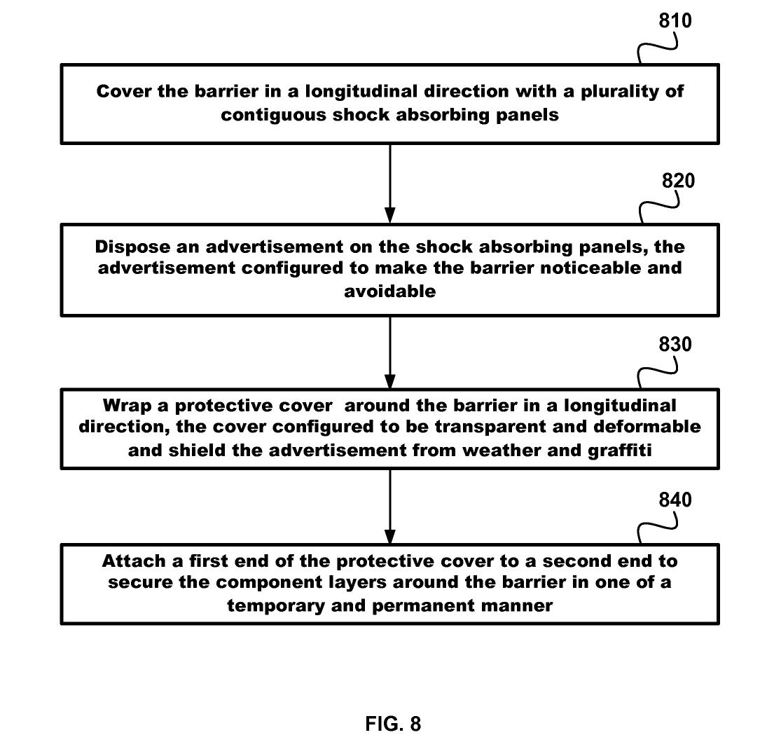

FIG. 8 is a method for attaching an advertisement to a barrier in accordance with an embodiment of the present disclosure. The method includes covering 810 the barrier in a longitudinal direction with a plurality of contiguous shock absorbing panels. The method also includes disposing 820 an advertisement on the shock absorbing panels, the advertisement configured to make the barrier noticeable and avoidable. The method additionally includes wrapping 830 a protective cover around the barrier in a longitudinal direction, the cover configured to be transparent and deformable and shield the advertisement from weather and graffiti. Furthermore, the disclosed method includes attaching 840 a first end of the protective cover to a second end to secure the component layers around the barrier in one of a temporary and permanent manner.

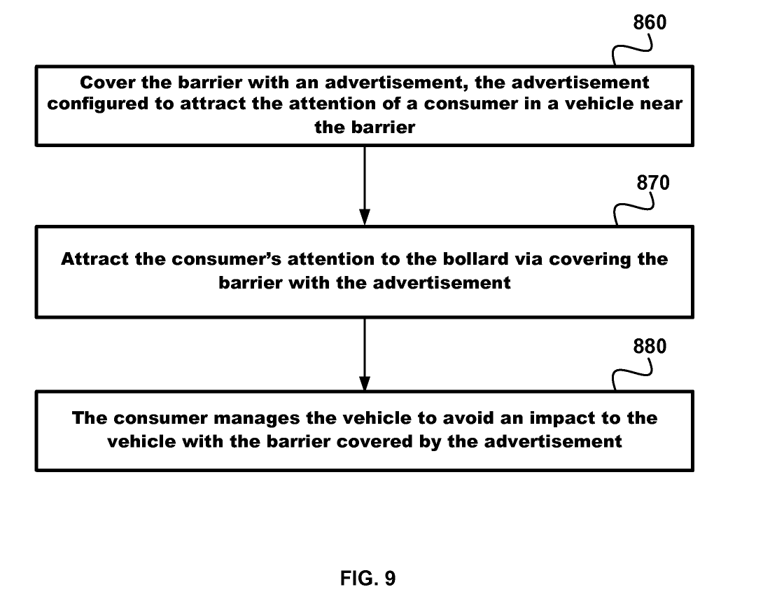

FIG. 9 is a flow chart of a method for protecting a vehicle from impact with a barrier in accordance with an embodiment of the present disclosure. The method includes covering 860 the bather with an advertisement configured to attract the attention of a consumer in a vehicle near the barrier. The method also includes attracting 870 the consumer's attention to the barrier via covering the barrier with the advertisement. The disclosed method additionally includes the consumer managing 880 the vehicle to avoid an impact to the vehicle with the bollard barrier covered with the advertisement.

Although the operations of the method(s) herein are shown and to described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims and their equivalents.

What is claimed is:

1. A barrier cover, comprising:
a shock absorbing component layer configured to absorb a shock and impact with a third object and substantially return to its original form;
a display component layer configured to make the barrier noticeable and avoidable and configured to be one of a disparate layer and an imprint onto the shock absorbing layer, and
a protective advertisement cover layer configured to be transparent and deformable and shield the advertisement from weather and graffiti.

2. The barrier cover of claim 1, wherein the display component layer comprises a message through advertising and variable presentment to attract and capture a customer's attention and therefore make it unlikely that the customer will bang his or her vehicle door against the barrier.

3. The barrier cover of claim 1, wherein the display component layer comprises an information kiosk configured to inform a consumer of one of a plurality of safety procedures for pumping gas and any other information deemed useful or necessary by a management of a premises of the barrier.

4. The barrier cover of claim 1, wherein the shock absorbing component layer may be comprised of a foam rubber material, an elastomeric material, a low durometer plastic and any combination thereof and any material capable of repeatedly absorbing impact from a third object and substantially returning to its original form.

5. The barrier cover of claim 1, wherein the shock absorbing component layer is configured into a plurality of contiguous panels comprising three hundred and sixty degree perimeter coverage in a longitudinal direction of a circular barrier, a rectilinear barrier, a pyramidal barrier, a conical barrier, a hoop barrier, a cylindrical bollard and any other shape of barrier.

6. The barrier cover of claim 1, wherein the advertisement component layer configured to make the bather noticeable and avoidable comprises a warning sign in safety yellow and any other appropriate attention capturing colors and graphics.

7. The barrier cover of claim 1, further comprising at least one rebate coupon dispenser disposed on the cover layer, the rebate coupons configured to be detachable from the cover for consumers, the rebate coupons also configured to attract attention to the barrier and make it noticeable and avoidable.

8. The barrier cover of claim 1, wherein the advertisement cover comprises at least one of a grommet pair and string, a snap pair, a hoop and loop complementary surfaces and any other adhesive material for affixing adjacent ends to each other or to adjacent layers to secure the component layers around the barrier in one of a temporary and permanent manner.

9. The barrier cover of claim 1, further comprising a plurality of extended height component layers configured to extend beyond a barrier height to provide an additional detectability to Recreational Vehicles (RV) and high clearance motor vehicles.

10. The barrier cover of claim 1, further comprising a shock activated audible alarm disposed under the cover layer, the alarm configured to alert a driver to impact with the barrier in circumstances where a driver may start to sideswipe a barrier by a sharp turn exiting a barrier protected pump station.

11. The barrier cover of claim 1, wherein at least one of the component layers may be imbued with a fluorescent pigment to facilitate a nighttime detectability and to facilitate reading an enclosed advertisement during nighttime hours.

12. The barrier cover of claim 1, wherein at least one of the component layers comprises at least one chemi-luminescent glow stick to facilitate nighttime detectability and to facilitate reading an enclosed advertisement during nighttime hours.

13. The barrier cover of claim 1, further comprising a chemi-luminescent glow panel component layer configured to facilitate nighttime detectability and to facilitate reading an enclosed advertisement during nighttime hours.

14. The barrier cover of claim 1, further comprising a flexible electronic display component layer including a plurality of LED (light emitting diodes) powered from one of a local DC battery, AC (alternating current) electric power and a solar panel, the LED configurable to flash at a variable rate and intensity.

15. The barrier cover of claim 1, further comprising a plurality of additional component layers configured to display, advertise, absorb shock and impact and protect a plurality of substrate component layers and the barrier.

16. The barrier cover of claim 1, wherein the shock absorbing component layer is configured to protect the third object coming into contact with the barrier, the third object comprising vehicles, persons, animals, shopping carts, sporting goods and any non-stationary object.

17. A method for attaching an advertisement to a barrier, comprising:
covering the barrier in a longitudinal direction with a plurality of contiguous shock absorbing panels;
disposing an advertisement on the shock absorbing panels, the advertisement configured to make the barrier noticeable and avoidable;
wrapping a protective cover around the barrier in a longitudinal direction, the cover configured to be transparent and deformable and shield the advertisement from weather and graffiti; and
attaching a first end of the protective cover to a second end to secure the component layers around the barrier in one of a temporary and permanent manner.

18. The method for attaching a cover to a barrier of claim 17, further comprising precasting a plurality of panels into a variety of barrier shapes and sizes and affixing the panels to the barrier to facilitate a snug placement around any barrier.

19. The method for attaching a cover to a barrier of claim 17, wherein attaching a first end of the protective cover to a second end further comprises tying a string through a plurality of grommets in the first end to a plurality of grommets in the second end.

20. A method for protecting a vehicle from impact with a barrier, comprising:
covering the barrier with an advertisement, the advertisement configured to attract an attention of a consumer in a vehicle near the barrier;
attracting the consumer's attention to the bollard via covering the barrier with the advertisement; and
the consumer managing the vehicle to avoid an impact to the vehicle with the barrier covered by the advertisement.
